(19) United States
(12) Patent Application Publication
(10) Pub. No.: US 2025/0096914 A1
(43) Pub. Date: Mar. 20, 2025

(54) INFORMATION PROCESSING SYSTEM, INFORMATION PROCESSING APPARATUS, INFORMATION PROCESSING METHOD, AND STORAGE MEDIUM

(71) Applicant: NEC Corporation, Minato-ku, Tokyo (JP)

(72) Inventors: Shohei Maruyama, Tokyo (JP); Yoshiaki Nishikawa, Tokyo (JP); Takeo Onishi, Tokyo (JP); Eiji Takahashi, Tokyo (JP)

(73) Assignee: NEC Corporation, Minato-ku, Tokyo (JP)

(21) Appl. No.: 18/727,406

(22) PCT Filed: Mar. 14, 2022
(86) PCT No.: PCT/JP2022/011336

§ 371 Date: Jul. 9, 2024

(51) Int. Cl. H04B 17/318; H04B 17/309; H04B 17/391

(52) U.S. Cl. CPC H04B 17/328; H04B 17/346; H04B 17/3912

(57) ABSTRACT

To estimate to what extent each of multiple causes affects communication degradation or communication failure, provided is an information processing system (1) including: an obtaining section (11) that obtains time series data of a radio indicator value that is an indicator of communication quality of wireless communication; an estimation section (12) that estimates an intensity of each of degradation causes of the communication quality due to a radio propagation environment, in accordance with the obtained time series data; and a derivation section (13) that derives an influence ratio in degradation of the communication quality for each of the degradation causes in accordance with the estimated intensities of the degradation causes.

### TECHNICAL FIELD

The present invention relates to an information processing system, an information processing apparatus, and an information processing method.

### BACKGROUND ART

The standard of wireless communication technology in recent years has evolved from 4G to 5G, and the development of next generation technologies is also promoted. With such development of the communication technologies, the amount of communication data and the communication speed have increased, and the number of users and the situation where users utilize wireless communication technologies have also increased. On the other hand, since various causes cause degradation of the communication quality or communication failure, it is desirable to study the causes and take some measures before interruption of communication.

For example, Patent Literature 1 discloses a monitoring system including a monitoring apparatus configured to: obtain an image as ambient information at a base station; receive terminal information indicating a state of a terminal apparatus; and control the base station based on a monitoring result of whether a cause that degrades the quality of wireless communication between the base station and the terminal apparatus exists or not, the monitoring result being obtained by using the obtained image and the received terminal information. This makes it possible to monitor a cause that degrades reception quality in wireless communication for each mobile communication terminal.

Further, Patent Literature 2 discloses a wireless communication system including: performing statistical processing of received power and carrier sense information for each wireless terminal; inferring the usage environment of the wireless terminals based on the result information of the statistical processing when the number of retransmissions increases; and inferring a failure cause based on the inferred usage environment of the wireless terminals. This makes it possible to infer a failure due to the usage environment of the wireless terminals.

### CITATION LIST

### Patent Literature

### Patent Literature 1

Japanese Patent Application Publication, Tokukai, No. 2018-6844

### Patent Literature 2

Japanese Patent Application Publication, Tokukai, No. 2014-116660

### SUMMARY OF INVENTION

### Technical Problem

However, the technique disclosed in Patent Literature 1 or the technique disclosed in Patent Literature 2 is a technique inferring whether there is a cause that degrades communication, or whether there is a cause of a particular communication failure; however, even with these technologies, it is difficult to estimate to what extent multiple causes affect communication degradation or communication failure.

An example aspect of the present invention has been made in view of this problem, and an example object thereof is to provide a technique for estimating to what extent each of multiple causes affects communication degradation or communication failure.

### Solution to Problem

An information processing system in accordance with an example aspect of the present invention includes: obtaining means for obtaining time series data of a radio indicator value that is an indicator of communication quality of wireless communication; estimation means for estimating an intensity of each of degradation causes of the communication quality due to a radio propagation environment, in accordance with the obtained time series data; and derivation means for deriving an influence ratio in degradation of the communication quality for each of the degradation causes in accordance with the estimated intensities of the degradation causes.

An information processing apparatus in accordance with an example aspect of the present invention includes: obtaining means for obtaining time series data of a radio indicator value that is an indicator of communication quality of wireless communication; estimation means for estimating an intensity of each of degradation causes of the communication quality due to a radio propagation environment, in accordance with the obtained time series data; and derivation means for deriving an influence ratio in degradation of the communication quality for each of the degradation causes in accordance with the estimated intensities of the degradation causes.

An information processing method in accordance with an example aspect of the present invention includes: an obtaining step of obtaining time series data of a radio indicator value that is an indicator of communication quality of wireless communication; an estimation step of estimating an intensity of each of degradation causes of the communication quality due to a radio propagation environment, in accordance with the obtained time series data; and a derivation step of deriving an influence ratio in degradation of the communication quality for each of the degradation causes in accordance with the estimated intensities of the degradation causes.

### Advantageous Effects of Invention

According to an example aspect of the present invention, it is possible to provide a technique for estimating to what extent each of multiple causes affects communication degradation or communication failure.

### BRIEF DESCRIPTION OF DRAWINGS

FIG. 1 is a block diagram illustrating the configuration of an information processing system 1 in accordance with a first example embodiment of the present invention.

FIG. 2 is a schematic diagram illustrating an example of information processing carried out by the information processing system 1.

FIG. 3 is a block diagram illustrating the configuration of an information processing apparatus 2 in accordance with the first example embodiment.

FIG. 4 is a flowchart illustrating the flow of an information processing method S1 in accordance with the first example embodiment.

FIG. 5 is a block diagram illustrating the configuration of an information processing apparatus 2A in accordance with a second example embodiment of the present invention.

FIG. 6 is a schematic diagram illustrating the details of processes carried out until an estimation section in accordance with the second example embodiment estimates degradation cause intensities.

FIG. 7 is a schematic diagram illustrating the flow of the training method of an estimation model, which serves as the estimation section in accordance with the second example embodiment.

FIG. 8 is a schematic diagram illustrating an example of a method of deriving influence ratios by a derivation section in accordance with the second example embodiment.

FIG. 9 illustrates an example of a function table that is provided in the derivation section in accordance with the second example embodiment instead of or in addition to a function.

FIG. 10 is a table showing examples of a measure taken against each degradation cause.

FIG. 11 is a flowchart illustrating the flow of an information processing method S2 in accordance with the second example embodiment.

FIG. 12 is a block diagram illustrating the configuration of an information processing apparatus 2B in accordance with a third example embodiment of the present invention.

FIG. 13 is a diagram illustrating the configuration of an example of an information processing system in accordance with a fourth example embodiment of the present invention.

FIG. 14 is a diagram illustrating the configuration of another example of the information processing system in accordance with the fourth example embodiment.

FIG. 15 is a diagram illustrating the configuration of another example of the information processing system in accordance with the fourth example embodiment.

FIG. 16 is a diagram illustrating the configuration for implementing the information processing apparatuses by software.

### EXAMPLE EMBODIMENTS

### First Example Embodiment

A first example embodiment of the present invention will be described in detail with reference to the drawings. The present example embodiment is a basic form of example embodiments described later.

### Configuration of Information Processing System

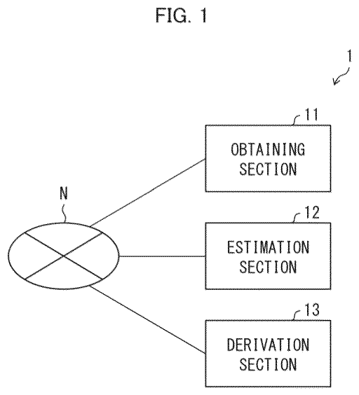

The following description will discuss the configuration of an information processing system 1 in accordance with the present example embodiment with reference to FIG. 1. FIG. 1 is a block diagram illustrating the configuration of the information processing system 1.

As illustrated in FIG. 1, the information processing system 1 includes an obtaining section 11, an estimation section 12, and a derivation section 13. The obtaining section 11, the estimation section 12, and the derivation section 13 are connected via an information communication network N such as an internet so that they can communicate with each other. Part of or the entirety of each of the obtaining section 11, the estimation section 12, and the derivation section 13 may be disposed on a cloud.

The obtaining section 11 obtains time series data of a radio indicator value that is an indicator of the communication quality of wireless communication. The estimation section 12 estimates the intensity of each of degradation causes of the communication quality due to a radio propagation environment, in accordance with the time series data obtained by the obtaining section 11. The derivation section 13 derives the influence ratio in degradation of the communication quality for each of the degradation causes in accordance with the intensities of the degradation causes estimated by the estimation section 12. The wireless communication is communication using radio waves, and may refer to communication at, for example, 4G, LTE, 5G, local 5G, 6G, etc. The propagation environment is a physical environment, an electromagnetic environment, or the like that affects the propagation of radio waves, and, for example, may be an object that blocks radio waves such as mountains or structures, an object that reflects radio waves such as structures or atmospheric conditions, multiple radio wave transmission sources, or the like. The obtaining section 11, the estimation section 12, and the derivation section 13 are aspects of obtaining means, estimation means, and derivation means, respectively, recited in the claims.

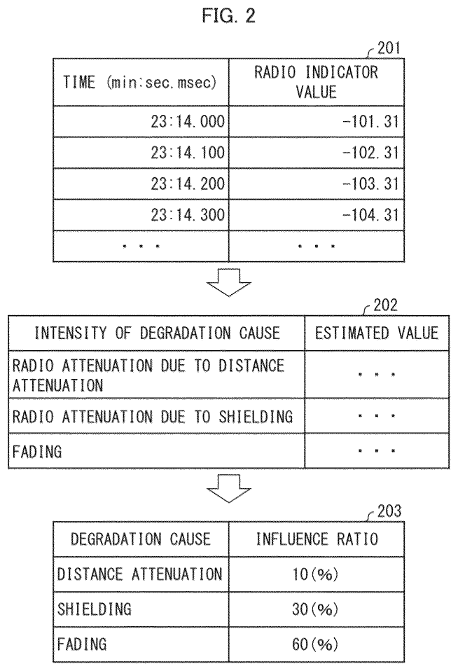

FIG. 2 is a schematic diagram illustrating an example of information processing carried out by the obtaining section 11, the estimation section 12, and the derivation section 13. As illustrated in 201 of FIG. 2, the obtaining section 11 obtains a radio indicator value that is an indicator of the communication quality. Here, as an example, the communication quality may be defined how correct the transmitted information is received or how fast the information is received, in the wireless communication. The communication quality may be defined by, for example, a data transmission volume (throughput), a data communication delay time, jitter, the number of hybrid automatic retransmissions, the number of excesses in hybrid automatic retransmissions, the number of radio link control retransmissions, a block error ratio (to be described later), a packet loss rate, and a bit error rate. The communication quality may also be defined by values associated with a received signal of a radio wave such as RSRP [dBm] (RSRP will be described later), RSRQ [dB] (RSRQ will be described later), RSSI [dBm] (RSSI will be described later), and SINR [dB] (SINR will be described later). A state in which the communication quality is lower than a preferable communication quality is referred to as communication degradation or communication failure. Degradation causes are individual causes each causing the communication degradation or communication failure.

As illustrated in 202 of FIG. 2, the estimation section 12 estimates the intensity of each degradation cause (hereinafter also referred to as “degradation cause intensity”). The degradation cause intensity is an index that affects the magnitude of degradation caused by the degradation cause thereof. As an example, as the degradation cause intensity, the estimation section 12 may estimate, for example, a degradation cause intensity associated with radio attenuation due to the radio wave distance, a degradation cause intensity associated with radio attenuation due to shielding, and a degradation cause intensity associated with fading. The types of the degradation cause intensity are not limited to the examples shown in 202 of FIG. 2.

203 in FIG. 2 is an example of the influence ratios derived by the derivation section 13 for respective degradation causes of radio waves. In the present example embodiment, the influence ratio refers to a rate or value indicating to what extent its degradation cause affects the degradation or the like of the communication quality. In this example, referring to the estimated values of the degradation cause intensities shown in 202 of FIG. 2, the derivation section 13 derives that the influence ratios of the respective degradation causes of radio waves are 10% in radio attenuation due to the distance, 30% in radio attenuation due to shielding, and 60% in fading.

As described in the foregoing, the information processing system 1 in accordance with the present example embodiment employs a configuration of including: the obtaining section 11 that obtains time series data of a radio indicator value that is an indicator of communication quality of wireless communication; the estimation section 12 that estimates an intensity of each of degradation causes of the communication quality due to a radio propagation environment, in accordance with the obtained time series data; and the derivation section 13 that derives an influence ratio in degradation of the communication quality for each of the degradation causes in accordance with the estimated intensities of the degradation causes. Thus, according to the information processing system 1 in accordance with the present example embodiment, it is possible to achieve an example advantage of being capable of estimating to what extent each of multiple causes affects communication degradation or communication failure.

### Information Processing Apparatus 2

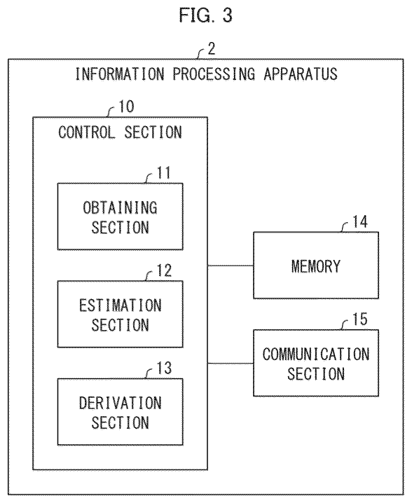

Next, an information processing apparatus 2 in accordance with the present example embodiment will be described with reference to the drawing. FIG. 3 is a block diagram illustrating the configuration of the information processing apparatus 2. As illustrated in FIG. 2, the information processing apparatus 2 includes a control section 10, a memory 14, and a communication section 15. The control section 10 includes an obtaining section 11, an estimation section 12, and a derivation section 13. The obtaining section 11, the estimation section 12, and the derivation section 13 have configurations and functions similar to those of the obtaining section 11, the estimation section 12, and the derivation section 13 described in relation to the abovementioned information processing system 1, respectively, and thus descriptions thereof are omitted here.

As an example, the memory 14 may include various types of volatile random access memories (RAMs), nonvolatile read only memories (ROMs), and the like. In a ROM, various programs are stored. Various programs may be, for example, an obtaining program, an estimation program, a derivation program, and the like. The control section 10 loads the various programs into a RAM and executes the programs, to implement functions as the obtaining section 11, the estimation section 12, and the derivation section 13.

The communication section 15 performs information communication to the exterior of the information processing apparatus under the control of the control section 10. As an example, the obtaining section 11 obtains the radio indicator value via the communication section 15. The derivation section 13 may transmit the derived influence ratio to the exterior via the communication section 15.

It should be noted that the obtaining section 11, the estimation section 12, the derivation section 13, the memory 14, and the communication section 15 is not necessarily configured as a single apparatus. For example, some of the obtaining section 11, the estimation section 12, the derivation section 13, the memory 14, and the communication section 15 may be incorporated in another housing separated from the information processing apparatus 2.

As described in the foregoing, the information processing apparatus 2 in accordance with the present example embodiment includes: the control section 10 including the obtaining section 11, the estimation section 12, and the derivation section 13; the memory 14; and the communication section 15. The information processing apparatus 2 employing such a configuration can achieve an example advantage similar to that achieved by the information processing system 1 described above.

### Flow of Information Processing Method S1

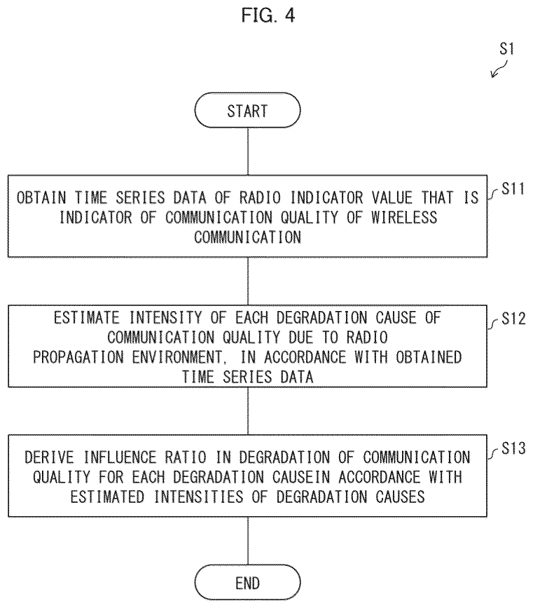

The following description will discuss the flow of an information processing method S1 in accordance with the present example embodiment with reference to FIG. 4. FIG. 4 is a flowchart illustrating the flow of the information processing method S1 carried out by the abovementioned information processing system 1 or information processing apparatus 2. As illustrated in FIG. 4, the information processing method S1 includes step S11, step S12, and step S13.

In step S11, the obtaining section 11 obtains time series data of a radio indicator value that is an indicator of the communication quality of wireless communication (obtaining step). The type of the radio indicator value is as described above.

Then, in step S12, the estimation section 12 estimates the intensity of each degradation cause of the communication quality due to a radio propagation environment, in accordance with the obtained time series data (estimation step). The meanings of the term “degradation cause” and “degradation cause intensity” are as described above.

Then, in step S13, the derivation section 13 derives the influence ratio in degradation of the communication quality for each degradation cause in accordance with the estimated intensities of the degradation causes (derivation step). The meaning of the term “influence ratio” is as described above.

As described in the foregoing, the information processing method S1 in accordance with the present example embodiment employs a configuration of including: the obtaining step of deriving an ratio influence in degradation of the communication quality for each of the degradation causes in accordance with the estimated intensities of the degradation causes; the estimation step of estimating an intensity of each of degradation causes of the communication quality due to a radio propagation environment, in accordance with the obtained time series data; and the derivation step of deriving an influence ratio in degradation of the communication quality for each of the degradation causes in accordance with the estimated intensities of the degradation causes. Thus, according to the information processing method S1 in accordance with the present example embodiment, it is possible to achieve an example advantage of being capable of estimating to what extent each of multiple causes affects communication degradation or communication failure. Therefore, it is possible to take a measure to remove degradation causes with a greater influence ratio, and to efficiently improve the communication quality.

### Second Example Embodiment

A second example embodiment of the present invention will be described in detail with reference to the drawings. The same reference numerals are given to constituent elements which have functions identical with those described in the first example embodiment, and descriptions as to such constituent elements are omitted as appropriate.

### Configuration of Information Processing Apparatus

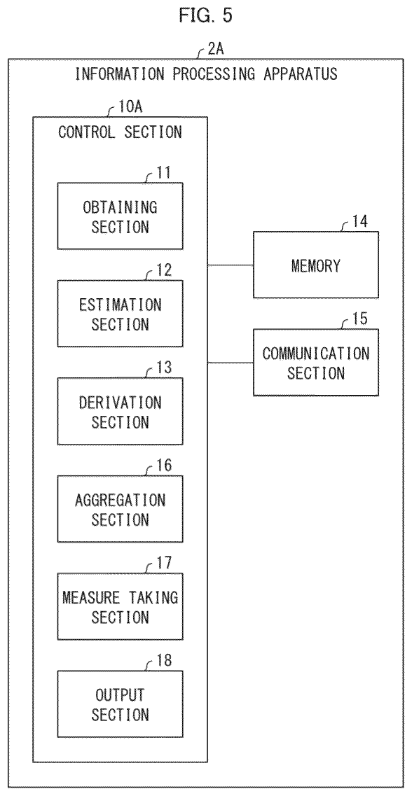

FIG. 5 is a block diagram illustrating the configuration of an information processing apparatus 2A in accordance with the second example embodiment. As illustrated in FIG. 5, the information processing apparatus 2A includes a control section 10A, a memory 14, and a communication section 15. The control section 10A includes an obtaining section 11, an estimation section 12, a derivation section 13, an aggregation section 16, a measure taking section 17, and an output section 18.

The information processing apparatus 2A illustrated in FIG. 5 is depicted to have the sections being collectively arranged in as a single apparatus, but is not limited to such a configuration. For example, part of or the entirety of each section may be disposed at different locations and may be connected so that they can perform information communication with each other. Part of or the entirety of each section may be disposed on a cloud. This also applies to the example embodiments described below.

The obtaining section 11 obtains time series data of a radio indicator value that is an indicator of the communication quality of radio communication. The estimation section 12 estimates a degradation cause intensity of each of degradation causes of the communication quality due to the radio propagation environment, with reference to the time series data obtained by the obtaining section 11. In the present example embodiment, the estimation section 12 is an estimation model obtained by machine learning. The derivation section 13 derives the influence ratio for each of the degradation causes in accordance with values of a common degradation index obtained by converting the respective intensities of the degradation causes estimated by the estimation section 12. The specific processing contents of the estimation section 12 and the derivation section 13 will be described later. The memory 14 and the communication section 15 are the same as the memory 14 and the communication section 15 described in relation to the information processing apparatus 2 in accordance with the first example embodiment, respectively, and thus descriptions thereof are omitted here.

The aggregation section 16 aggregates the time series data of the radio indicator value obtained by the obtaining section 11 and stores the aggregated data in the memory 14 in format of, for example, comma separated value (CSV) data. The estimation section 12 reads in the CSV data from the memory 14 and estimates the degradation cause intensities.

The measure taking section 17 executes a measure to improve the communication quality in accordance with the influence ratio derived by the derivation section 13. Specifically, the measure taking section 17 extracts a degradation cause having a greater influence ratio, selects a measure for removing the extracted degradation cause, and executes the selected measure. As an example, the measure taking section 17 may select a measure against a degradation cause having the greatest influence ratio and execute the selected measure.

Alternatively, the measure taking section 17 may extract two or more degradation causes in descending order of the influence ratios until the sum of the influence ratios of the extracted causes reaches a predetermined degree, and then the measure taking section 17 may select a measure or measures against these degradation causes and execute the selected ones. The types of measures will be described later.

The output section 18 outputs externally the influence ratios derived by the derivation section 13. The outputted influence ratios are displayed on a screen or the like (not illustrated), for example. The user can check the outputted influence ratios, consider which measure(s) to take, and execute the measure(s). Alternatively, the output section 18 may transmit the influence ratios to an external measure control apparatus (not illustrated). The measure control apparatus may receive the influence ratios and take the necessary measure or measures.

### Flow of Estimation Process of Degradation Cause Intensity

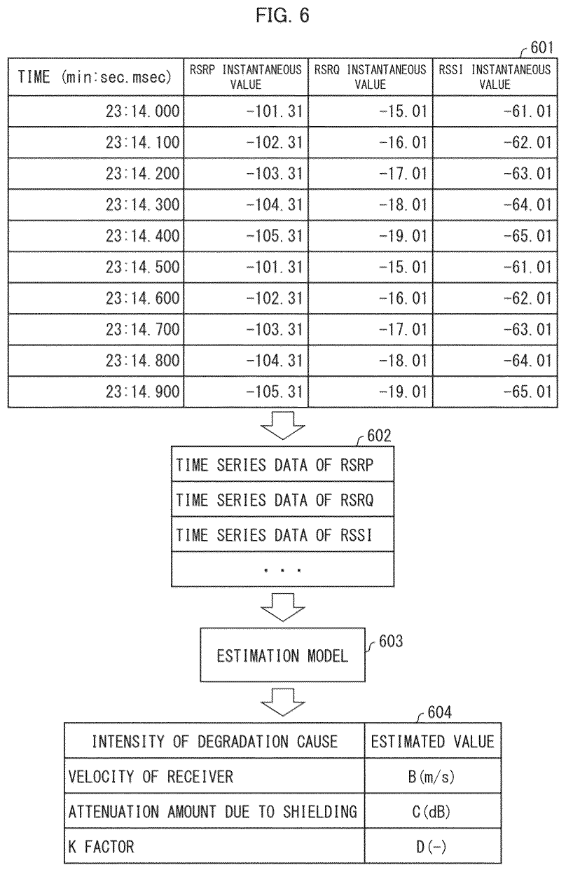

Next, an estimation process carried out by the estimation section 12 will be described. FIG. 6 is a schematic diagram illustrating the details of processes carried out until the estimation section 12 estimates degradation cause intensities.

601 in FIG. 6 is a specific example of time series data of the radio indicator values obtained by the obtaining section 11. The radio indicator values fluctuate when the communication quality of radio waves lowers due to degradation causes of radio waves. A specific example of the degradation causes will be described later.

The example shown in 601 of FIG. 6 indicates, as the radio indicator values obtained by the obtaining section 11, an instantaneous value of a reference signal received power (hereinafter referred to as “RSRP”), an instantaneous value of a reference signal received quality (hereinafter referred to as “RSRQ”), and an instantaneous value of a received signal strength indicator (hereinafter referred to as “RSSI”), which are obtained every 0.1 milliseconds at a certain time.

The RSRP is a received power (in units of dBm etc.) of the reference signal per one resource element (band 15 kHz) from the transmitter. The RSSI is a received power of the entire band (in units of dBm etc.). The RSRQ is obtained by dividing RSRP by RSSI and by multiplying the quotient by the number of resource blocks (in units of dB etc.). The obtaining section 11 receives a reference signal and a communication signal transmitted from the transmitter (e.g., a mobile radio base station), and calculates the RSRP, the RSRQ, and the RSSI.

These radio indicator values are merely examples, and the radio indicator values obtained by the obtaining section 11 may be some of these, and may include any radio indicator value other than these. For example, as another radio indicator value, a signal-to-interference-plus-noise power ratio (hereinafter referred to as “SINR”) or the like may be used. The SINR is a ratio of the noise power including interference with respect to the signal power (in units of dB etc.).

602 of FIG. 6 is CSV data aggregated by the aggregation section 16 and stored in the memory 14. As described above, the types of time series data (radio indicator values) are not limited to the RSRP, the RSRQ, and the RSSI illustrated in the figure.

As illustrated in 603 of FIG. 6, the estimation section 12 obtains the time series data 602 and estimates the degradation cause intensities. As described before, in the present second example embodiment, the estimation section 12 is an estimation model obtained by machine learning. Specifically, the estimation section 12 is a model obtained by training with use of time series data obtained in advance by performing simulation with use of the degradation causes. That is, the estimation section 12 is a trained estimation model in which the time series data of the radio indicator values is received as input and the degradation cause intensities are outputted. The method of performing machine learning for the estimation model will be described later.

604 of FIG. 6 is an example of estimated values of the degradation cause intensities estimated by the estimation section 12. The degradation cause intensity is an index that affects the magnitude of degradation caused by the degradation cause thereof. In this example, the estimation section 12, which is an estimation model, obtains the CSV data 602 of the radio indicator values, and outputs B (m/s) that is the velocity of the receiver, C (dB) that is the radio attenuation amount due to shielding, and D (−) that is the K factor.

The velocity of the receiver is a degradation cause intensity associated with a degradation cause that is radio attenuation due to the radio wave distance. The radio attenuation due to the radio wave distance is attenuation of a radio wave due to an increase in distance between the transmitter and the receiver. The radio attenuation due to the radio wave distance can also be referred to as degradation due to the radio wave distance.

The attenuation amount due to shielding is a degradation cause intensity associated with a degradation cause that is radio attenuation due to radio wave shielding. The radio attenuation due to the radio wave shielding can also be referred to as degradation due to the radio wave shielding.

K factor is a degradation cause intensity associated with a degradation cause that is radio wave fading. The fading is radio wave fluctuation in time caused by various causes such as interference, reflection, polarization, and the like, and can also be referred to as degradation due to radio wave fading. The K factor is given as the ratio of the power of the direct wave to the power of the sum of the N elementary waves.

In the present example embodiment, the examples including distance, shielding, and fading have been described as the degradation causes of radio waves. However, the degradation causes are not limited thereto. For example, interference, congestion, and handover may be included in addition to the degradation causes described above. That is, the degradation causes may include at least one selected from the group consisting of distance, shielding, fading, interference, congestion, and handover.

Degradation due to interference is degradation that is caused by radio waves transmitted from multiple transmitters (base stations or wireless terminals) interfering with each other. Congestion is degradation due to insufficient frequency allocation to the receiver. Degradation due to handover is degradation caused by a wireless terminal present near the boundary of cells of two adjacent base stations repeating handover between the two base stations.

### Training Method of Estimation Model

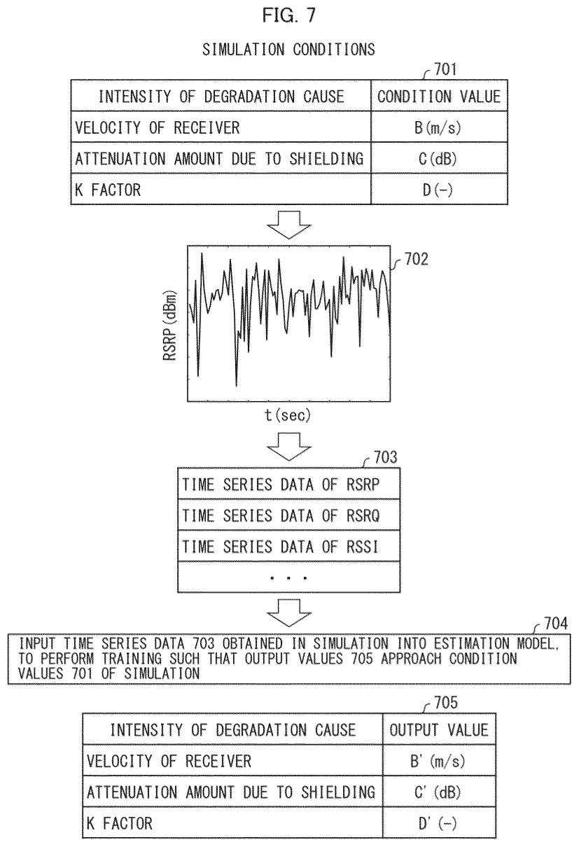

Next, a training method of the estimation model will be described. FIG. 7 is a schematic diagram illustrating the flow of the training method of the estimation model, which serves as the estimation section 12. The training of the estimation model is performed by using a communication state simulator of a radio wave (hereinafter referred to as “simulator”). The simulator performs a simulation in which changes in received level are calculated by varying in time, for example, a transmission condition such as a transmitting method and transmission output of the transmitter, a receiving condition such as a receiving method and receiving capability of the receiver, and/or a spatial condition such as the distance between the transmitter and the receiver, and an a type of an obstacle.

701 in FIG. 7 is an example of condition values of the strengths of the degradation cause intensities, which are conditions of the simulation. The user inputs such condition values as one of the simulation conditions, and obtains an output value outputted from the simulator. The simulation conditions are preferably conditions simulating an actual radio wave environment for which the influence ratios is desired to be derived by using the information processing apparatus 2A. Use of the estimation model trained in simulation conditions simulating an actual radio wave environment allows the influence ratio to be derived with high accuracy. For example, in the example illustrated in 701 of FIG. 7, it is desired to estimate degradation cause intensities of radio waves between a robot or a work equipment (receiver) that is self-propelled and conducts work when receiving a control signal, and a transmitter that transmits a control signal for operating the receiver, in a factory or a work site, so that the abovementioned degradation cause intensities are set as parameters. However, when it is desired to estimate degradation cause intensities in different radio wave transmission and reception environments, it is preferable to set different degradation cause intensities.

702 of FIG. 7 is an example of the radio indicator value outputted from the simulator. The vertical axis of 702 represents the RSRP (dBm) and the horizontal axis represents the time (t). Although a graph in this example indicates the time change of the RSRP, the data output is not limited thereto as described above. 703 in FIG. 7 is data obtained as CSV data by aggregating the time series data of the radio indicator values outputted from the simulator.

Next, as illustrated in 704 in FIG. 7, the user inputs the time series data 703 obtained by the simulation into the estimation section 12 (estimation model), and performs training such that the output values 705 approach the respective condition values 701 of the simulation. 705 in FIG. 7 is an example of the output values of the degradation cause intensities outputted by the estimation section 12. In the example illustrated here, B′ denotes the velocity of the receiver, C′ denotes the radio attenuation amount due to shielding, and D′ denotes the K factor. The estimation model is trained such that these values approach B, C, and D, respectively, which are the condition values of the simulation. That is, the estimation model updates the parameters and the weights of the estimation model so as to reduce errors between the output values 705 and the condition values 701 of the simulation. Then, the update is terminated at the time when the errors between the output values and the condition values fall within a predetermined range.

### Derivation of Influence Ratio From Degradation Cause Intensity

Next, a method will be described in which the derivation section 13 derives the influence ratios from the degradation cause intensities. First, the derivation section 13 obtains the values of the common degradation index by converting the respective intensities of the degradation causes in accordance with a parameter specified based on data of a value of the degradation index obtained by performing simulation with use of the degradation causes. The derivation section 13 includes conversion means generated in advance for converting each degradation cause intensity into a value of the common degradation index. As an example, the conversion means may be a function or a function table containing predetermined parameters. Next, the derivation section 13 derives the influence ratio for each degradation cause for degradation of the communication quality, with reference to values of the common degradation index.

In the present example embodiment, the degradation index value is a numerical value obtained by expressing each of the degrees of degradation due to multiple degradation causes by a specific evaluation value. This specific evaluation value is referred to as the common degradation index value. The common degradation index value is not limited in type as long as it can quantify each of the degrees of degradation due to different degradation causes.

As an example, the degradation index may be information associated with at least one selected from the group consisting of a data transmission volume (throughput), a data communication delay time, jitter, the number of hybrid automatic retransmissions, the number of excesses in hybrid automatic retransmissions, the number of radio link control retransmissions, a block error ratio (hereinafter, referred to as “BLER”), a packet loss rate, and a bit error rate. The data transmission volume (throughput) is the data transmission volume (bit) per unit time. The data communication delay time is a time until data transmitted from the transmitter is received by the receiver. The jitter is that data arrival order is reversed or data cannot be received due to fluctuations in data transmission time. The number of hybrid automatic retransmissions is the number of automatic retransmissions in the hybrid system (automatic retransmissions request system in which a code informing the presence or absence of data corruption is added to the packet). The number of excesses in hybrid automatic retransmissions is the number of cases in which the number of automatic retransmissions by the hybrid system exceeds a predetermined number of times. The number of radio link control retransmissions is the number of times that an IP packet unsuccessfully transmitted is retransmitted in the radio link control sublayer. The BLER is a ratio of blocks with errors to the total number of blocks transmitted. The packet loss rate is a rate of packets that have not reached a receiver with respect to packets that have sent. The bit error rate is a rate of some data resulting in errors with respect to data that have sent.

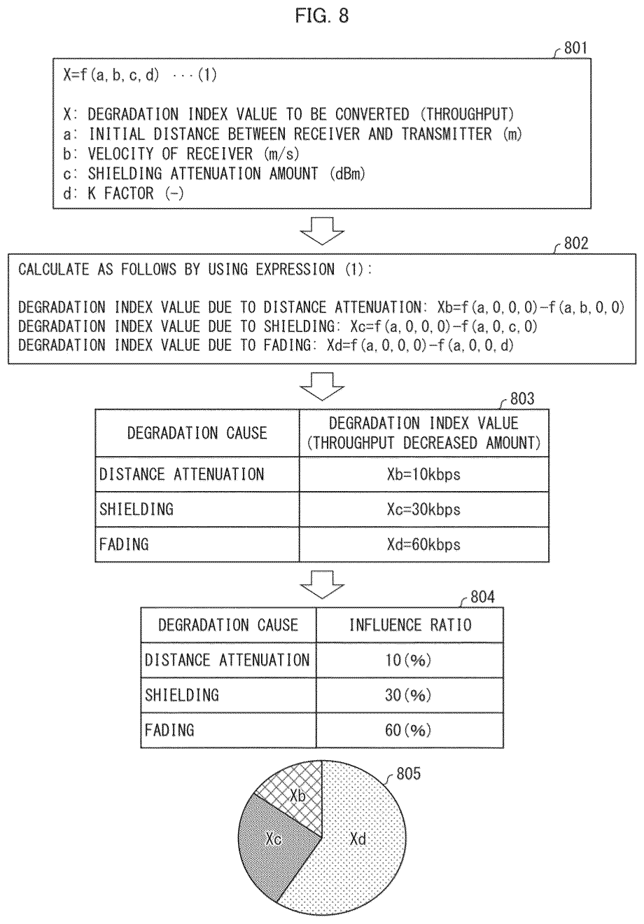

A method of deriving the influence ratios by the derivation section 13 from the degradation cause intensities will be specifically described with reference to the drawings. FIG. 8 is a schematic diagram illustrating an example of the method in which the derivation section 13 obtains values of the common degradation index by converting the degradation cause intensities, and then derives the influence ratios.

### Conversion to Common Degradation Index Value

801 in FIG. 8 is function expression (1) that is an example of a function provided in the derivation section 13. The function f expressed by the expression (1) is a function that receives parameters a, b, c, and d as input, and outputs a degradation index value X. In this example, the degradation index value X is the amount of decrease in throughput (data transmission volume); however, a similar function may be set for other degradation index values. The parameter a is an initial distance (m) between the receiver and the transmitter, the parameter b is the velocity of the receiver (m/s), the parameter c is the shielding attenuation amount (dBm), and the parameter d is the K factor (−) of fading. In this example, the parameter a is an initial distance between the receiver and the transmitter, and is a constant. Any unit may be employed and be set depending on an environment to be actually applied.

As illustrated in 802 in FIG. 8, the derivation section 13 calculates the degradation index value as follows using the expression (1).

$$Degradation index value due to distance attenuation : Xb = f ( a , 0 , 0 , 0 ) - f ( a , b , 0 , 0 ) \qquad ( 1 )$$

$$Degradation index value due to shielding : Xc = f ( a , 0 , 0 , 0 ) - f ( a , 0 , c , 0 ) \qquad ( 2 )$$

$$Degradation index value due to fading : Xd = f ( a , 0 , 0 , 0 ) - f ( a , 0 , 0 , d ) \qquad ( 3 )$$

The results of the calculations are shown in 803 of FIG. 8. In this example, the amount of decrease in throughput Xb due to distance attenuation is calculated to be 10 (kbps), the amount of decrease in throughput Xc due to shielding is calculated to be 30 (kbps), and the amount of decrease in throughput Xd due to fading is calculated to be 60 (kbps). Through the foregoing processing, the derivation section 13 can convert the degradation cause intensities into the amounts of decrease in throughput, which is the values of the common degradation index.

### Derivation of Influence Ratio

Next, in accordance with the amounts of the values of this degradation index, the derivation section 13 derives the influence ratio for each degradation cause. As an example, the derivation section 13 may derive the rate of the degradation index value for each degradation cause as the influence ratio for the degradation cause. Specifically, as illustrated in 804 of FIG. 8, the influence ratio in distance attenuation is derived to be 10 (%), the influence ratio in shielding is derived to be 30 (%), and the influence ratio in fading is derived to be 60 (%). Further, as illustrated in 805 of FIG. 8, the influence ratios may be displayed in a pie chart.

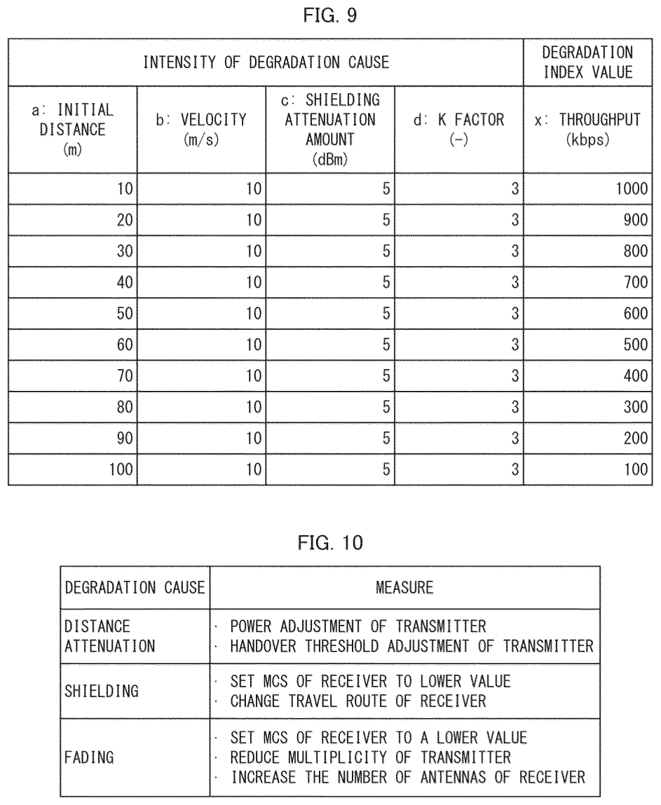

FIG. 9 illustrates an example of a function table that is provided in the derivation section 13 instead of or in addition to the function. As illustrated in FIG. 9, to the function table, throughputs X are given as the values of the degradation index in accordance with values of the initial distance a, the velocity of receiver movement b, and the attenuation amount c due to shielding, and the K factor d. This function table may be generated in advance by simulation. This simulation may be carried out by the abovementioned simulator.

A value of the degradation index of any of the degradation cause intensities that are not included in the function table of FIG. 9, may be calculated by interpolation from numerical values in the neighborhood. Values of any degradation index other than the throughput can also be calculated by simulation. Such a table may be provided for each degradation index value, a proper function table to be used may be selected depending on the radio indicator value obtained. The abovementioned function expression (1) may be generated from data obtained by the simulator (e.g., a function table illustrated in FIG. 9).

As described above, when the influence ratios for respective degradation causes are obtained, the measure taking section 17 can extract a deterioration cause with a greater influence ratio, and select a measure to eliminate the degradation cause, to take the selected measure. The following description will discuss the measure taken by the measure taking section 17 to improve communication quality.

### Measures

FIG. 10 is a table showing examples of the measure taken against each degradation cause. As illustrated in the figure, examples of the measure against the distance attenuation may include power adjustment of the transmitter, handover threshold adjustment of the transmitter, or the like. The power adjustment of the transmitter is a measure to increase the transmission output. The handover threshold adjustment of the transmitter is to lower the threshold of the received power undergoing the handover. The handover threshold adjustment is effective in the case of degradation caused by frequent occurrence of the handover.

Examples of the measure against degradation due to shielding may include setting a lower modulation and coding scheme (MCS) of the receiver or changing a travel route of the receiver. The MCS is a combination of a data modulation system and channel coding ratio, and is adjusted to improve SINR. Changing the travel route of the receiver is a method of inhibiting degradation due to shielding by going around of a shielding object located between the transmitter and the receiver.

Examples of the measure against degradation due to fading may include setting a lower MCS of the receiver, reducing the multiplicity of the transmitter, increasing the number of antennas of the receiver, and the like. The settings of the MCS are as described above. A method of reducing the multiplicity of transmitters can reduce degradation due to interference or the like. Increasing the number of antennas of the receiver is a method of reducing degradation by increasing the receiving capability.

By taking the abovementioned measures for the transmitter or receiver, it is possible to reduce degradation of the communication quality. Such measures may be taken for individual transmitters or receivers. Alternatively, when it is considered that there is a degradation cause common to multiple transmitters or multiple receivers present in an area, such measures may be taken for the transmitters or the receivers. Further, as an example, the measure taking section 17 may be provided in the base station and take any measure to increase the transmission capability of the base station with reference to the influence ratios obtained from the derivation section 13. A control signal may be transmitted from the base station to every receiver so as to take any measure to increase the receiving capability.

Alternatively, as described above, the user may check the influence ratios outputted by the output section 18, consider which measure(s) to take, and execute the measure(s). For example, the user may take a measure such as changing the installation location of the base station, changing the number of antennas of the receiver, reducing the multiplicity of the transmitter, and the like. Meanwhile, examples of the measure that can be taken by the measure taking section 17 may include a power adjustment of the transmitter, and changing each parameter of the base station or the transmitter or receiver.

### Example Advantage of Information Processing Apparatus 2A

As described in the foregoing, the information processing apparatus 2A in accordance with the present example embodiment employs a configuration in which the derivation section 13 derives the influence ratio for each of the degradation causes in accordance with values of the common degradation index obtained by converting the respective intensities of the degradation causes. There are various kinds of degradation causes, and the degradation cause intensities thereof also have different unit dimensions depending on the degradation causes. However, since the degradation cause intensities, which cannot be simply compared with each other, are converted into values of the common degradation index for reference, it is possible to derive the influence ratios indicating to what extent each degradation cause is involved in degradation of the communication quality.

That is, according to the: information processing apparatus 2A in accordance with the present example embodiment, it is possible to achieve an example advantage of being capable of comparing the degradation cause intensities by means of values of the common degradation index, in addition to the example advantage achieved by the information processing apparatus 2 in accordance with the first example embodiment.

Further, the information processing apparatus 2A in accordance with the present example embodiment employs a configuration in which the derivation section 13 obtains the values of the common degradation index by converting the respective intensities of the degradation causes in accordance with a parameter specified based on data of a value of the degradation index obtained by performing simulation with use of the degradation causes. Thus, the information processing apparatus 2A in accordance with the present example embodiment achieves an example advantage of being capable of perform conversion into the degradation index value with high accuracy based on simulation.

Further, the information processing apparatus 2A in accordance with the present example embodiment employs a configuration in which the estimation section 12 is a model obtained by training with use of time series data obtained in advance by performing simulation with use of the degradation causes. Therefore, according to the information processing apparatus 2A in accordance with the present example embodiment, it is possible to achieve an example advantage of accurately estimating the degradation cause intensities.

### Information Processing Method S2

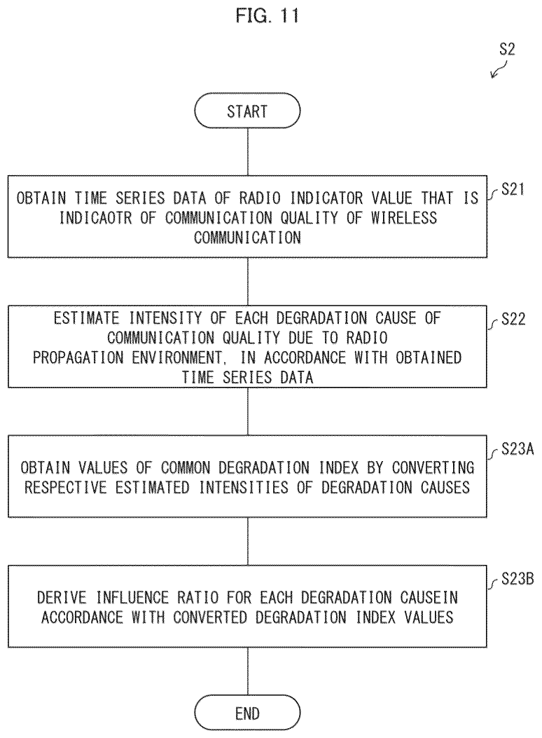

Next, an information processing method S2 in accordance with the second example embodiment will be described with reference to the drawing. FIG. 11 is a flowchart illustrating the flow of the information processing method S2 carried out by the abovementioned information processing apparatus 2A. As illustrated in FIG. 11, the information processing method S2 includes steps S21 to S23B.

The information processing method including: an obtaining step of obtaining time series data of a radio indicator value that is an indicator of communication quality of wireless communication;

an estimation step of estimating an intensity of each of degradation causes of the communication quality due to a radio propagation environment, in accordance with the obtained time series data; and

a derivation step of deriving an influence ratio in degradation of the communication quality for each of the degradation causes in accordance with the estimated intensities of the degradation causes.

In step S21, the obtaining section 11 obtains time series data of a radio indicator value that is an indicator of the communication quality of wireless communication (obtaining step). The type of the radio indicator value is as described above.

Then, in step S22, the estimation section 12 estimates the intensity of each degradation cause of the communication quality due to a radio propagation environment, in accordance with the time series data obtained by the obtaining section 11 (estimation step).

Next, in step S23A, the derivation section 13 obtains values of a common degradation index by converting the respective intensities of the degradation causes estimated by the estimation section 12 (conversion step).

Next, in step S23B, the derivation section 13 derives the influence ratio for each of the degradation causes in accordance with the values of the converted degradation index (derivation step).

According to the foregoing information processing method S2, since the degradation cause intensities, which cannot be simply compared with each other, are converted into values of the common degradation index for reference, it is possible to derive the influence ratios indicating to what extent each degradation cause contributes to degradation of the communication quality. Thus, in addition to the example advantage achieved by the information processing method S1 in accordance with the first example embodiment, it is possible to achieve an example advantage of being capable of comparing the degradation cause intensities by means of values of the common degradation index.

### Third Example Embodiment

A third example embodiment of the present invention will be described in detail with reference to the drawings. The same reference numerals are given to constituent elements which have functions identical with those described in the first and second example embodiments, and descriptions as to such constituent elements are not repeated.

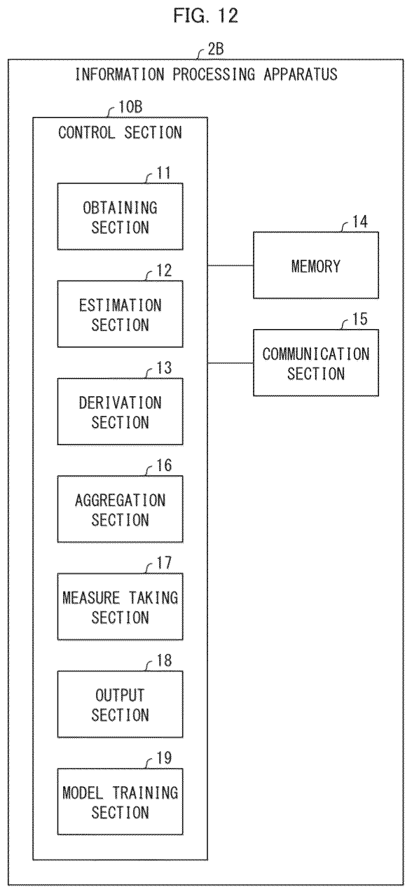

FIG. 12 is a block diagram illustrating the configuration of an information processing apparatus 2B in accordance with the third example embodiment. As illustrated in FIG. 12, the information processing apparatus 2B includes a control section 10B, a memory 14, and a communication section 15. The control section 10B includes an obtaining section 11, an estimation section 12, a derivation section 13, an aggregation section 16, a measure taking section 17, an output section 18, and a model training section 19. As described in the second example embodiment, the estimation section 12 is an estimation model that can be obtained by machine learning. Part of or the entirety of each section described above may be disposed at different locations and may be connected so that they can perform information communication with each other. Part of or the entirety of each of the abovementioned sections may be disposed on a cloud.

The configurations and functions of the obtaining section 11, the estimation section 12, the derivation section 13, the aggregation section 16, the measure taking section 17, the output section 18, the memory 14, and the communication section 15 are the same as those of the corresponding sections described in the first or second example embodiment. Thus, the descriptions thereof are omitted and only the model training section 19 will be described hereunder.

The model training section 19 trains the estimation model, which serves as the estimation section 12. As an example, a method of training the estimation model may include the method described with reference to FIG. 7 in the second example embodiment. In this case, the model training section 19 externally obtains condition values of degradation cause intensities of the simulation, and simulation results of radio indicator values under the conditions. As an example, the model training section 19 may obtain, from an external database via the communication section 15, the condition values of the simulation and the simulation results of the radio indicator values under the conditions. Alternatively, the model training section 19 may obtain the condition values of the simulation and the simulation result of the radio indicator value under the condition, through user input.

Next, the model training section 19 transmits the obtained condition values of the simulation and the simulation results of the radio indicator values to the estimation section 12. The estimation section 12 updates the parameters and the weights of the estimation model so as to reduce errors between estimated values of degradation cause intensities estimated based on the simulation results of the radio indicator values, and the condition values of the simulation. The model training section 19 then terminates the update when the errors between the estimated values and the condition values fall within a predetermined range. This terminates the training of the estimation model.

The estimation section 12 may be an estimation model that has already been trained, or alternatively, may be an estimation model that has undergone no training. In a case where the estimation section 12 is an estimation model that has already been trained, the estimation model may be further trained using additional condition values of the simulation and additional simulation results of the radio indicator values.

### Fourth Example Embodiment

A fourth example embodiment of the present invention will be described in detail with reference to the drawings. The same reference numerals are given to constituent elements which have functions identical with those described in the first to third example embodiments, and descriptions as to such constituent elements are not repeated.

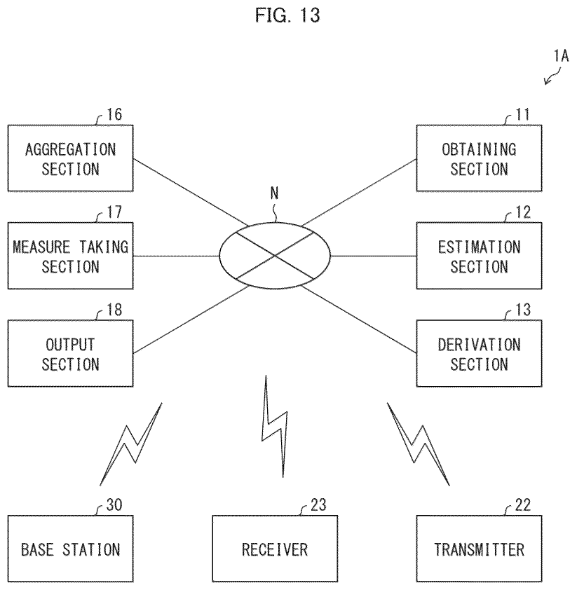

FIG. 13 is a diagram illustrating the configuration of an example of an information processing system in accordance with the fourth example embodiment. An information processing system 1A in accordance with the present fourth example embodiment includes an obtaining section 11, an estimation section 12, a derivation section 13, an aggregation section 16, a measure taking section 17, and an output section 18.

In a communication system in which information is transmitted from a transmitter 22 to a receiver 23 via a base station 30, the information processing system 1A monitors both the communication quality between the transmitter 22 and the base station 30, and the communication quality between the base station 30 and the receiver 23, and then, takes a necessary measure. That is, the obtaining section 11 obtains both radio indicator values between the transmitter 22 and the base station 30 and radio indicator values between the base station 30 and the receiver 23, the estimation section 12 estimates degradation cause intensities by using these radio indicator values, and the derivation section 13 derives the influence ratios in degradation of the communication quality from the degradation cause intensities. Then, the measure taking section 17 selects a measure in accordance with the influence ratios, generates a measure signal, and transmits the signal to the transmitter 22, the receiver 23, or the base station 30, to thereby take the measure. In this example embodiment, the measure taking section 17 is disposed at a different location from the base station 30, the transmitter 22, and the receiver 23.

In the example illustrated in FIG. 13, both the transmitter 22 and the receiver 23 communicate with the base station 30 operated by a carrier; however, the present invention is not limited thereto. For example, the system may be one in which the transmitter 22 and the receiver 23 communicate directly with each other, such as a local 5G employing equipment independent of the base station operated by a carrier. In this case, the information processing system 1A monitors the quality of the communication from the transmitter 22 to the receiver 23 and takes a necessary measure. Alternatively, a user who sees information outputted from the output section 18 may appropriately take a measure. These variations are also applicable in the first to third example embodiments described above and the following example embodiment.

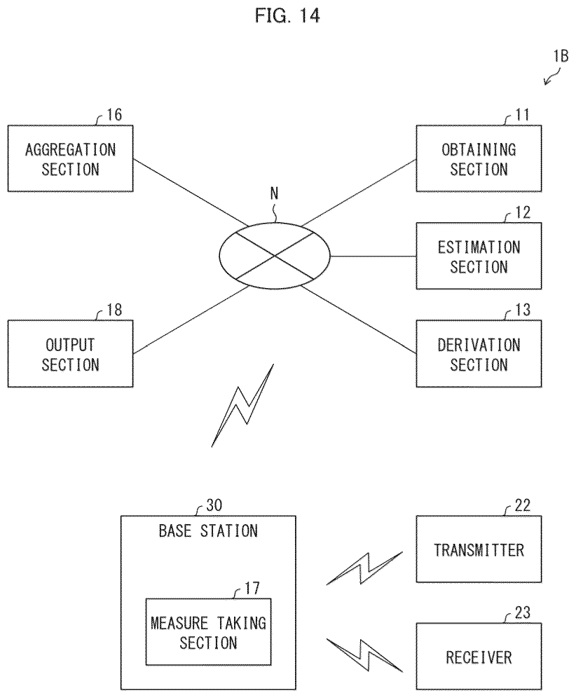

FIG. 14 is a diagram illustrating the configuration of another example of the information processing system in accordance with the fourth example embodiment. An information processing system 1B in accordance with the present fourth example embodiment includes an obtaining section 11, an estimation section 12, a derivation section 13, an aggregation section 16, a measure taking section 17, and an output section 18. It should be noted that, in this example, the measure taking section 17 is disposed in the base station 30. The information processing system 1B monitors both the communication quality between the transmitter 22 and the base station 30, and the communication quality between the base station 30 and the receiver 23, and then, takes a necessary measure. The measure taking section 17 appropriately generates and transmits a signal of a measure for the base station 30, a measure for the transmitter 22, or a measure for the receiver 23. In this example, since the measure taking section 17 is disposed in the base station 30, there is an advantage that the measure signal can be directly transmitted from the base station 30 to the transmitter 22 or the receiver 23. There is also an advantage of providing a wider choice of options of measures taken to the base station 30.

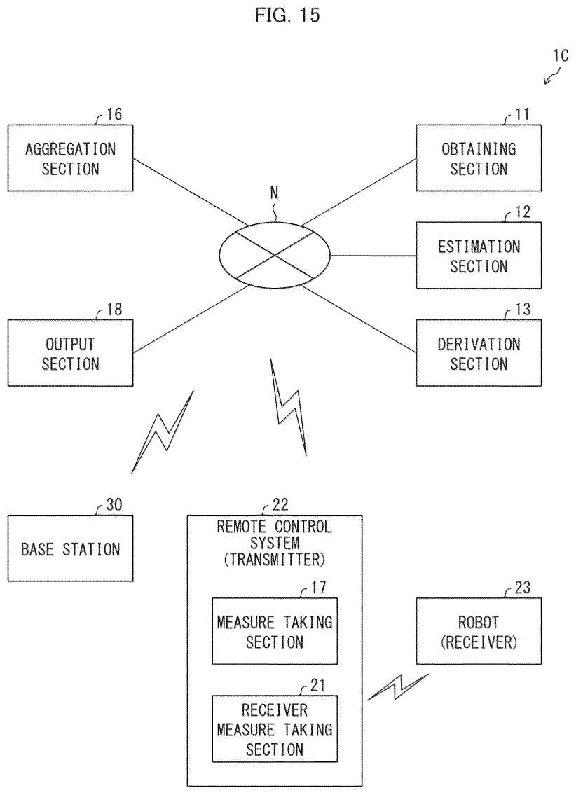

FIG. 15 is a diagram illustrating the configuration of another example of the information processing system in accordance with the fourth example embodiment. An information processing system 1C in accordance with the present fourth example embodiment includes an obtaining section 11, an estimation section 12, a derivation section 13, an aggregation section 16, a measure taking section 17, and an output section 18. It should be noted that, in this example, a transmitter 22 is a transmitter disposed in a remote control system 22 that remotely controls a working robot or a work machine, which serves as a receiver 23. The remote control system 22 includes a measure taking section 17 and a receiver measure taking section 21. The information processing system 1C monitors both the communication quality between the transmitter 22 and the base station 30, and the communication quality between the base station 30 and the receiver 23, and then, takes a necessary measure. The receiver measure taking section 21 also serves as a control apparatus of the receiver 23, and is configured to obtain a measure signal that is generated by the measure taking section 17 and is to be transmitted to the receiver 23, and to transmit the obtained signal to the receiver 23. In this way, part of the information processing system 1C is disposed in the facilities including the information communication apparatus, to monitor the communication quality of the information communication apparatus to take a necessary measure, so that it is possible to ensure stable operation of the facilities. For example, if the travel route of the receiver 23 cannot be changed, any other measure may be taken. Thus, by providing the remote control system 22 with the measure taking section 17, it is possible to take a measure suitable for remote control.

### Example Advantages of Information Processing Systems 1A to 1C

As described in the foregoing, the information processing systems 1A to 1C in accordance with the present example embodiment achieves an example advantage of being capable of ensuring the stable operation of the facilities that perform the information communication, in addition to the example advantage achieved by the information processing system 1 in accordance with the first example embodiment.

### Software Implementation Example

Some or all of the functions of the information processing systems 1, 1A, 1B, and 1C, and the information processing apparatuses 2, 2A, 2B (hereinafter referred to as “information processing apparatus or the like) may be implemented by hardware such as an integrated circuit (IC chip) or may be alternatively implemented by software.

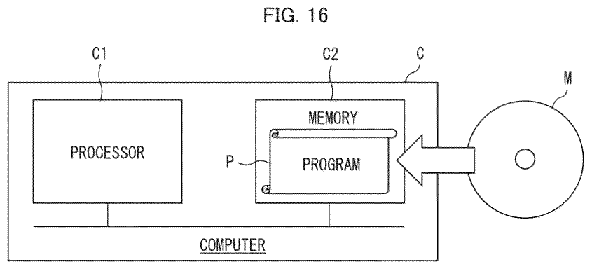

In the latter case, the information processing apparatus or the like is implemented by, for example, a computer that executes instructions of a program that is software implementing the foregoing functions. FIG. 16 illustrates an example of such a computer (hereinafter, referred to as “computer C”). The computer C includes at least one processor C1 and at least one memory C2. The at least one memory C2 stores a program P for causing the computer C to operate as the information processing apparatus or the like. The processor C1 of the computer C retrieves the program P from the memory C2 and executes the program P, so that the functions of the information processing apparatus or the like are implemented.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when the program P is executed and/or in which various kinds of data are temporarily stored. The computer C may further include a communication n interface for transmitting and receiving data to and from another apparatus. The computer C may further include an input/output interface for connecting input/output apparatuses such as a keyboard, a mouse, a display and/or a printer.

The program P can be stored in a non-transitory tangible storage medium M that is readable by the computer C. Such a storage medium M may be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some of or all of the foregoing example embodiments can also be described as below. Note, however, that the present invention is not limited to the following example aspects.

### Supplementary Note 1

An information processing system including: obtaining means for obtaining time series data of a radio indicator value that is an indicator of communication quality of wireless communication; estimation means for estimating an intensity of each of degradation causes of the communication quality due to a radio propagation environment, in accordance with the obtained time series data; and derivation means for deriving an influence ratio in degradation of the communication quality for each of the degradation causes in accordance with the estimated intensities of the degradation causes.

With this configuration, it is possible to estimate to what extent each of multiple causes affects communication degradation or communication failure.

### Supplementary Note 2

The information processing system according to Supplementary note 1, wherein the derivation means derives the influence ratio for each of the degradation causes in accordance with values of a common degradation index obtained by converting the respective intensities of the degradation causes.

With this configuration, since intensities of the degradation causes, which cannot be simply compared with each other, are converted into values of the common degradation index for reference, it is possible to derive the influence ratios indicating to what extent each degradation cause contributes to degradation of the communication quality.

### Supplementary Note 3

The information processing system according to Supplementary note 2, wherein the derivation means obtains the values of the common degradation index by converting the respective intensities of the degradation causes in accordance with a parameter specified based on data of a value of the degradation index obtained by performing simulation with use of the degradation causes.

With this configuration, it is possible to perform conversion into values of the degradation index accurately based on the simulation.

### Supplementary Note 4

The information processing system according to any one of Supplementary notes 1 to 3, wherein the estimation means is a model obtained by training with use of time series data obtained in advance by performing simulation with use of the degradation causes.

With this configuration, it is possible to accurately estimate the intensities of the degradation causes.

### Supplementary Note 5

The information processing system according to any one of Supplementary notes 1 to 4, further including measure taking means for taking a measure e for improving the communication quality in accordance with the derived influence ratios.

With this configuration, since it is possible to selectively take a measure against a degradation cause with a greater influence ratio, it is possible to efficiently improve the communication quality.

### Supplementary Note 6

The information processing system according to any one of Supplementary notes 1 to 5, further including output means for outputting the derived influence ratios.

Since this configuration enables the user to confirm the influence ratios, the user can take a measure in accordance with the influence ratios, resulting in an efficient improvement in communication quality.

### Supplementary Note 7

The information processing system according to any one of Supplementary notes 1 to 6, wherein the radio indicator value includes at least one selected from the group consisting of a reference signal received power, a reference signal received quality, a received signal strength indicator, and a signal-to- interference-plus-noise power ratio.

With this configuration, it is possible to estimate the intensities of degradation causes using various radio indicator values.

### Supplementary Note 8

The information processing system according to any one of Supplementary notes 1 to 7, wherein the degradation causes include at least one selected from the group consisting of distance, shielding, fading, interference, congestion, and handover.

With this configuration, the influence ratios can be derived for various degradation causes, so that it is possible to take a measure in accordance with various degradation causes.

### Supplementary Note 9

The information processing system according Supplementary note 2 or 3, wherein the degradation index is information associated with at least one selected from the group consisting of a data transmission volume, a data communication delay time, jitter, the number of hybrid automatic retransmissions, the number of excesses in hybrid automatic retransmissions, the number of radio link control retransmissions, a block error ratio, a packet loss rate, and a bit error rate.

This configuration makes it possible to perform the conversion into the various degradation index values, so that it is possible to use values of the appropriate common degradation index in accordance with the characteristics of the communication system.

### Supplementary Note 10

The information processing system according to Supplementary note 4, further including training means for training the model.

With this configuration, it is possible to improve accuracy by training the estimation model for estimating the intensities of the degradation causes while monitoring the communication quality of the communication system.

### Supplementary Note 11

An information processing apparatus including: obtaining means for obtaining time series data of a radio indicator value that is an indicator of communication quality of wireless communication; estimation means for estimating an intensity of each of degradation causes of the communication quality due to a radio propagation environment, in accordance with the obtained time series data; and derivation means for deriving an influence ratio in degradation of the communication quality for each of the degradation causes in accordance with the estimated intensities of the degradation causes.

With this configuration, it is possible to achieve an example advantage similar to that achieved by Supplementary note 1.

### Supplementary Note 12

The information processing apparatus according to Supplementary note 11, wherein the derivation means derives the influence ratio for each of the degradation causes in accordance with values of a common degradation index obtained by converting the respective intensities of the degradation causes.

With this configuration, it is possible to achieve an example advantage similar to that achieved by Supplementary note 2.

### Supplementary Note 13

The information processing apparatus according to Supplementary note 12, wherein the derivation means obtains the values of the common degradation index by converting the respective intensities of the degradation causes in accordance with a parameter specified based on data of a value of the degradation index obtained by performing simulation with use of the degradation causes.

With this configuration, it is possible to achieve an example advantage similar to that achieved by Supplementary note 3.

### Supplementary Note 14

The information processing apparatus according to any one of Supplementary notes 11 to 13, wherein the estimation means is a model obtained by training with use of time series data obtained in advance by performing simulation with use of the degradation causes.

With this configuration, it is possible to achieve an example advantage similar to that achieved by Supplementary note 4.

### Supplementary Note 15

The information processing apparatus according to any one of Supplementary notes 11 to 14, further including measure taking means for taking a measure for improving the communication quality with reference to the derived influence ratios.

With this configuration, it is possible to achieve an example advantage similar to that achieved by Supplementary note 5.

### Supplementary Note 16

The information processing apparatus according to any one of Supplementary notes 11 to 15, further including output means for outputting the derived influence ratios.

With this configuration, it is possible to achieve an example advantage similar to that achieved by Supplementary note 6.

### Supplementary Note 17

An information processing method including: an obtaining step of obtaining time series data of a radio indicator value that is an indicator of communication quality of wireless communication; an estimation step of estimating an intensity of each of degradation causes of the communication quality due to a radio propagation environment, in accordance with the obtained time series data; and a derivation step of deriving an influence ratio in degradation of the communication quality for each of the degradation causes in accordance with the estimated intensities of the degradation causes.

With this configuration, it is possible to achieve an example advantage similar to that achieved by Supplementary note 1.

### Supplementary Note 18

The information processing method according to Supplementary note 17, wherein the derivation step is a step of deriving the influence ratio for each of the degradation causes in accordance with values of a common degradation index obtained by converting the respective intensities of the degradation causes.

With this configuration, it is possible to achieve an example advantage similar to that achieved by Supplementary note 2.

### Supplementary Note 19

The information processing method according to Supplementary note 18, wherein the derivation step is a step of obtaining the values of the common degradation index by converting the respective intensities of the degradation causes in accordance with a parameter specified based on data of a value of the degradation index obtained by performing simulation with use of the degradation causes.

With this configuration, it is possible to achieve an example advantage similar to that achieved by Supplementary note 3.

### Supplementary Note 20

The information processing method according to any one of Supplementary notes 17 to 19, wherein the estimation step is carried out by a model obtained by training with use of time series data obtained in advance by performing simulation with use of the degradation causes.

With this configuration, it is possible to achieve an example advantage similar to that achieved by Supplementary note 4.

### Supplementary Note 21

The information processing method according to any one of Supplementary notes 17 to 20, further including a measure taking step of taking a measure for improving the communication quality in accordance with the derived influence ratios.

With this configuration, it is possible to achieve an example advantage similar to that achieved by Supplementary note 5.

### Supplementary Note 22

The information processing method according to any one of Supplementary notes 17 to 21, further including an output step of outputting the derived influence ratios.

With this configuration, it is possible to achieve an example advantage similar to that achieved by Supplementary note 6.

### Supplementary Note 23

A program for causing a computer to operate as the information processing system according to any one of Supplementary notes 1 to 10, the program causing the computer to function as each of the foregoing means.

### Additional Remark 3

Furthermore, some of or all of the foregoing example embodiments can also be described as below.

An information processing system including at least one processor, the at least one processor carrying out an obtaining process, an estimation process, a derivation process.

Note that the information processing system may further include a memory. The memory may store a program for causing the processor to carry out the obtaining process, the estimation process, and the derivation process. The program may be stored in a computer-readable non-transitory tangible storage medium.

### REFERENCE SIGNS LIST

1, 1A, 1B, 1C Information processing system
2, 2A, 2B Information processing apparatus
11 Obtaining section
12 Estimation section
13 Derivation section
14 Memory
15 Communication section
16 Aggregation section
17 Measure taking section
18 Output section
19 Model training section
21 Receiver measure taking section
22 Transmitter
23 Receiver
30 Base station

What is claimed is:

1. An information processing system comprising at least one processor, the at least one processor carrying out:
an obtaining process of obtaining time series data of a radio indicator value that is an indicator of communication quality of wireless communication;
an estimation process of estimating an intensity of each of degradation causes of the communication quality due to a radio propagation environment, in accordance with the obtained time series data; and
a derivation process of deriving an influence ratio in degradation of the communication quality for each of the degradation causes in accordance with the estimated intensities of the degradation causes.

2. The information processing system according to claim 1, wherein the derivation process derives the influence ratio for each of the degradation causes in accordance with values of a common degradation index obtained by converting the respective intensities of the degradation causes.

3. The information processing system according to claim 2, wherein the derivation process obtains the values of the common degradation index by converting the respective intensities of the degradation causes in accordance with a parameter specified based on data of a value of the degradation index obtained by performing simulation with use of the degradation causes.

4. The information processing system according to claim 1, wherein the estimation process is carried out by a model obtained by training with use of time series data obtained in advance by performing simulation with use of the degradation causes.

5. The information processing system according to claim 1, wherein the at least one processor further carries out a measure taking process of taking a measure for improving the communication quality in accordance with the derived influence ratios.

6. The information processing system according to claim 1, wherein the radio indicator value includes at least one selected from the group consisting of a reference signal received power, a reference signal received quality, a received signal strength indicator, and a signal-to-interference-plus-noise power ratio.

7. The information processing system according to claim 1, wherein the degradation causes include at least one selected from the group consisting of distance, shielding, fading, interference, congestion, and handover.

8. The information processing system according to claim 2, wherein the degradation index is information associated with at least one selected from the group consisting of a data transmission volume, a data communication delay time, jitter, the number of hybrid automatic retransmissions, the number of excesses in hybrid automatic retransmissions, the number of radio link control retransmissions, a block error ratio, a packet loss rate, and a bit error rate.

9. An information processing apparatus comprising at least one processor, the at least one processor carrying out:
an obtaining process of obtaining time series data of a radio indicator value that is an indicator of communication quality of wireless communication;
an estimation process of estimating an intensity of each of degradation causes of the communication quality due to a radio propagation environment, in accordance with the obtained time series data; and
a derivation process of deriving an influence ratio in degradation of the communication quality for each of the degradation causes in accordance with the estimated intensities of the degradation causes.

10. The information processing apparatus according to claim 9, wherein the derivation process derives the influence ratio for each of the degradation causes in accordance with values of a common degradation index obtained by converting the respective intensities of the degradation causes.

11. The information processing apparatus according to claim 10, wherein the derivation process obtains the values of the common degradation index by converting the respective intensities of the degradation causes in accordance with a parameter specified based on data of a value of the degradation index obtained by performing simulation with use of the degradation causes.

12. The information processing apparatus according to claim 9, wherein the estimation process is carried out by a model obtained by training with use of time series data obtained in advance by performing simulation with use of the degradation causes.

13. The information processing apparatus according to claim 9, wherein the at least one processor further carries out a measure taking process of taking a measure for improving the communication quality in accordance with the derived influence ratios.

14. The information processing apparatus according to claim 9, wherein the at least one processor further carries out an output process of outputting the derived influence ratios.

15. An information processing method comprising:
an obtaining step of obtaining time series data of a radio indicator value that is an indicator of communication quality of wireless communication;
an estimation step of estimating an intensity of each of degradation causes of the communication quality due to a radio propagation environment, in accordance with the obtained time series data; and
a derivation step of deriving an influence ratio in degradation of the communication quality for each of the degradation causes in accordance with the estimated intensities of the degradation causes.

16. The information processing method according to claim 15, wherein the derivation step is a step of deriving the influence ratio for each of the degradation causes in accordance with values of a common degradation index obtained by converting the respective intensities of the degradation causes.

17. The information processing method according to claim 16, wherein the derivation step is a step of obtaining the values of the common degradation index by converting the respective intensities of the degradation causes in accordance with a parameter specified based on data of a value of the degradation index obtained by performing simulation with use of the degradation causes.

18. The information processing method according to claim 15, wherein the estimation step is carried out by a model obtained by training with use of time series data obtained in advance by performing simulation with use of the degradation causes.

19. The information processing method according to claim 15, further comprising a measure taking step of taking a measure for improving the communication quality in accordance with the derived influence ratios.

20. (canceled)

21. A non-transitory storage medium storing a program for causing a computer to function as the information processing apparatus according to claim 9, the program causing the information processing apparatus to carry out the obtaining process, the estimation process, and the derivation process.
